(19) United States
(12) Patent Application Publication
(10) Pub. No.: US 2026/0359891 A1
(43) Pub. Date: Nov. 12, 2026

(54) A COMPUTER NETWORK STABILIZATION SYSTEM AND METHOD

(71) Applicant: ISLAMIC DEVELOPMENT BANK INSTITUTE, Jeddah (SA)

(72) Inventors: Sami ALSUWAILEM, Jeddah (SA); Hilal HOUSSAIN, Jeddah (SA); Salman SYED ALI, Jeddah (SA)

(73) Assignee: ISLAMIC DEVELOPMENT BANK INSTITUTE, Jeddah (SA)

(21) Appl. No.: 19/107,924

(22) PCT Filed: Aug. 30, 2023
(86) PCT No.: PCT/IB2023/058554

§ 371 Date: Feb. 28, 2025

(30) Foreign Application Priority Data
Sep. 1, 2022 (SG) 10202250873B

(51) Int. Cl. G06Q 40/04; H04L 9/00

(52) U.S. Cl. CPC G06Q 40/04; H04L 9/50

(57) ABSTRACT

A computer-implemented network stabilization method and system, the system comprising: a controller; a first computing system) having a centralized network architecture; and a second computing system having a decentralized network architecture. The controller is configured to receive a plurality of commands, to convert into a set of computer-executable actions, to generate a first command signal and a second command signal according to one or more control parameters that are generated by or accessible by the controller, and to send the first command signal to the first computing system and the second command signal to the second computing system.

### FIELD OF THE INVENTION

The present invention relates to a computer network stabilization system and method.

### BACKGROUND

Computerization of various functions in banking and capital markets has proved valuable in providing, for example, greater security, prompter funds transfers, and more efficient transaction settlement. However, capital markets remain vulnerable to speculative booms and busts that can be damaging to economic progress, and some of these swings are at least partly due to automation. For example, the ‘flash crash’ that led to losses of $315 billion in European equities on 3 May 2022 highlights the risks from computer-initiated sell orders exacerbating a single human error (see Bloomberg, 2022). The first flash crash occurred on May 6, 2010, when the Dow Jones Industrial Average dropped almost 1,000 points within 10 minutes. The plunge cost $1 trillion. Flash crashes occurred in equities, foreign exchange (FX), bonds, as well as cryptocurrencies (see The Balance, 2022).

The repeated occurrences of flash crashes in financial markets are a source of increasing concern to regulators and market authorities. Stability and efficiency, therefore, are important properties of financial markets but can be at odds with each other. It is well-known in engineering that a rapid response system tends to be unstable: stability indicates an innate resistance to change, whereas a quick response requires the opposite (see, for example, Stewart, 2013 and Das et al., 2011). The objective of the current invention is to design an algorithm for stabilizing organized markets without compromising efficiency.

In a free market, price is a function of supply and demand, and in particular the difference or gap therebetween. When supply exceeds demand, price tends to decrease, but when demand exceeds supply, the price tends to increase. In organized exchanges, the orders to sell (supply) and to buy (demand) are automated. If the gap between supply and demand is driven purely by economic fundamentals, then the resulting price adjustment facilitates the normal functioning of the market. However, capital or financial markets can exhibit “excess volatilities”, i.e. volatilities not driven by economic fundamentals, which are harmful to economic progress. In some cases, authorities regulate with the goal of stabilizing capital markets, but typically at a huge cost to public funds and capital reserves. For example, stabilization funds have been proposed to stabilize such markets, but these funds have proved to be ineffective for several reasons: the resources (i.e. the amount of capital) needed for the fund is typically excessively large if it is to have a significant effect in capital markets; those resources are unlikely to be sustainable even if available; speculators can drain the resources of the fund in a relatively short period; and speculators can to a degree predict the fund's movements, which can make the fund ineffective even before it is exhausted.

‘Circuit breakers’ have also been proposed as a mechanism for containing price volatility in organized exchanges, as discussed by Alderighi, S., et al. in Circuit breakers and other market safeguards, World Federation of Exchanges (March 2021). Financial transaction taxes have been proposed for the same purpose: see Congressional Research Services, Financial Transactions Taxes: In Brief, R42078 crsreports.congress.gov (February 2021).

Cryptocurrencies could be useful in this regard if their market values were sufficiently stable. The stability of cryptocurrencies is essential if these currencies are to serve the real economy by facilitating the exchange of goods and services. Volatile cryptocurrencies, such as Bitcoin, cannot be reliably used as a measure of value and a medium of exchange. There exist—in general—two approaches to producing a stablecoin (that is, a coin of a cryptocurrency adapted to be stable):
i) Reserves: the coin is backed by reserves (e.g., US dollars, gold, a basket of commodities, etc.) obtained from users (e.g. deposits) or donations, or ICOs, etc.

ii) Algorithms: if the coin's price rises (e.g., against the USD), more coins are issued; if the coin's price declines, coins are destroyed or withdrawn from circulation.

Tether (trade mark), MakerDAO (trade mark), Havven (trade mark) and Libra (trade mark) employ the reserve approach, while Basis (trade mark), Ampl (trade mark), Fatfi (trade mark) and TerraUSD (trade mark) employ the algorithmic approach (though TerraUSD collapsed in early May 2022).

Firstly, however, and as discussed above, reserves are costly and are difficult to scale up. On the other hand, algorithmic stablecoins in reality are also based on (costly) reserves. For example, Basis (see Al-Naji, N., et al., 2018) in fact comprises more than one coin:
i) Basis, the core coin of the system, pegged to the USD;
ii) Bond tokens, which are auctioned off by the blockchain when it needs to shrink the supply of Basis, wherein the bond pays exactly 1 Basis coin when the price of Basis goes above $1; and
iii) Share tokens, which are fixed and provide the capital or reserves needed to stabilize the Basis value; shareholders provide stability and therefore receive dividends from the fees charged to users.

Secondly, the above-described algorithms (and others) governing stablecoins are reactive: they take effect only after the price has already changed. Additionally, the algorithm approach assumes (based on the quantity theory of money) that changes in money supply will automatically find their way to prices. For coins, this implies that changes in the quantity of coins will automatically be reflected in the currency exchange market (i.e., exchange of the coin with the USD). However, as has been shown in a number of studies, this assumption is unwarranted. Managing the quantity of money does not necessarily result in the desired change in prices. The “transmission mechanism” is a critical step in managing money supply and is omitted from these algorithms, which fail to allow for effects such as hoarding of stablecoins, and of the purchase of goods and services with the stablecoins outside the exchange market. In essence, these algorithms assume that users are most interested in the currency exchange market (exchange of coins with dollars) rather than in the goods market.

### SUMMARY OF THE INVENTION

It is an object of the present invention to provide a system with an improved balance of stability and efficiency, of use in managing certain financial markets including digital currencies.

According to a first aspect of the invention, there is provided a computer-implemented network stabilization method, the method comprising:
receiving a plurality of commands at a controller;
converting the commands with the controller into a set of computer-executable actions;
generating from the computer-executable actions with the controller a first command signal and a second command signal, according to one or more control parameters that are generated by or accessible by the controller;
sending the first command signal from the controller to a first computing system having a centralized network architecture; and
sending the second command signal from the controller to a second computing system having a decentralized network architecture;
wherein the first command signal is configured to control the first computing system to execute a first subset of the set of computer-executable actions; and
the second command signal is configured to control the second computing system to execute a second subset of the set of computer-executable actions.

The method can be used to reduce the volatility of the price of an asset (e.g., shares or coins) by managing the gap between supply and demand (such as expressed as a difference between market price and price limit). A defined deduction may be applied based on the gap, and the deductions are used as reserves to support the stability of the system. By managing the excess supply or demand, the method proactively reduces the pressure on the price (unlike existing systems that respond after a price change). Moreover, the method does not require upfront resources to support the stabilization mechanism. The parameters of the method are flexible so the method can accommodate various kinds of assets as well as stablecoins.

The second computing system may comprise a peer-to-peer network configured for hosting a publicly distributed ledger.

The commands may be indicative of purchases, sales, or other financial transactions.

The set of computer-executable actions may constitute a trade comprising a purchase and a sale.

In an embodiment, a first at least one of the commands is a purchase command indicative of a purchase of a product or asset, and a second at least one of the commands is a sale command indicative of a sale of the product or asset; converting the commands into the set of computer-executable actions comprises pairing or matching the purchase command and the sale command and generating a matched purchase and sale command; and generating the first command signal and the second command signal comprises forming a comparison between at least one parameter pertaining to the purchase command and at least one parameter pertaining to the sale command.

In an example, the at least one parameter pertaining to the purchase command and to the sale command is the price of the product or other asset (such that the comparison between the one parameter pertaining to the purchase command and the parameter pertaining to the sale command is a measure of the gap between, for example, the purchase price and the sale price or between market price and price limit); and generating the first command signal and the second command signal comprises generating a deduction (based, for example, on the comparison) applicable to the price, such that first command signal and the second command signal are both functions of the deduction.

For example, forming the comparison may comprise comparing a sell limit order and a buy market order and/or comparing a buy limit order and a sell market order.

In an embodiment, the gap between supply and demand is defined as a gap between market price and price limit. In one example, the gap G is defined to be an absolute magnitude of a (e.g. percentage) difference between market price and price limit, such as G=|P(m)−P(l)|/(max (P(m), P(l))) or |P(m)−P(l)|/P(m) or |P(m)−P(l)|/P(l) or |P(m)−P(l)|.

In an embodiment, the deduction is a function of the magnitude of the gap.

In an embodiment, the deduction is zero below a first threshold value of the gap. In this embodiment, the deduction may have a finite value above the first threshold value and a greater value above the second threshold value of the gap that is greater than the first threshold value.

The deduction may increase, for example, in a stepwise or in a continuous manner. For example, the deduction may be zero below a first threshold value of the gap, a small percentage deduction (e.g. between 2% and 4%) between first and second threshold values of the gap, and a greater percentage (e.g. between 40% and 100%) above the second threshold value of the gap.

The method may comprise generating the first command signal to comprise either the sale command adjusted according to the deduction and the purchase command, or the purchase command adjusted according to the deduction and the sale command; and generating the second command signal to comprise the deduction.

The first computing system may comprise the controller.

According to a second aspect of the invention, there is provided a network stabilization system, comprising:
a controller;
a first computing system having a centralized network architecture; and
a second computing system having a decentralized network architecture;
wherein the controller is configured to receive a plurality of commands, to convert the commands into a set of computer-executable actions, to generate from the computer-executable actions a first command signal and a second command signal according to one or more control parameters that are generated by or accessible by the controller, and to send the first command signal to the first computing system and the second command signal to the second computing system;
the first command signal is configured to control the first computing system to execute a first subset of the set of computer-executable actions; and
the second command signal is configured to control the second computing system to execute a second subset of the set of computer-executable actions.

The second computing system may comprise a peer-to-peer network configured for hosting a publicly distributed ledger. The commands may be indicative of purchases, sales or other financial transactions.

The set of computer-executable actions may constitute a trade comprising a purchase and a sale.

In an embodiment, a first at least one of the commands is a purchase command indicative of a purchase of a product or asset, and a second at least one of the commands is a sale command indicative of a sale of the product or asset; converting the commands by the controller into the set of computer-executable actions comprises pairing or matching the purchase command and the sale command and generating a matched purchase and sale command; and generating the first command signal and the second command signal by the controller comprises forming a comparison between at least one parameter pertaining to the purchase command and at least one parameter pertaining to the sale command.

For example, the at least one parameter pertaining to the purchase command and to the sale command may be price of the product or other asset (such that the comparison between the one parameter pertaining to the purchase command and the parameter pertaining to the sale command is a measure of the gap between the purchase price and the sale price); and generating the first command signal and the second command signal by the controller may comprise generating a deduction (based, for example, on the comparison) applicable to the price, such that first command signal and the second command signal are both functions of the deduction.

The first command signal may comprise either the sale command adjusted according to the deduction and the purchase command, or the purchase command adjusted according to the deduction and the sale command; and the second command signal the deduction.

In an embodiment, the first computing system comprises the controller.

According to a third aspect of the invention, there is provided a computer program comprising program code configured, when executed by one or more computing devices, to implement the method of the first aspect. According to this aspect, there is also provided a computer-readable medium (which may be non-transient), comprising such a computer program.

It should be noted that any of the various individual features of each of the above aspects of the invention, and any of the various individual features of the embodiments described herein including in the claims, can be combined as suitable and desired. In particular, the various embodiments and examples of the first aspect are also applicable to the second aspect.

### DRAWINGS

In order that the invention may be more clearly ascertained, embodiments will now be described by way of example with reference to the following drawing, in which:

FIG. 1 is a schematic architectural view of a stabilization system according to an embodiment of the present invention.

FIG. 2A is a schematic diagram of the exchange platform of the stabilization system of FIG. 1.

FIG. 2B is a schematic diagram of the stabilization network of the stabilization system of FIG. 1.

FIG. 2C is a schematic diagram of the controller platform of the stabilization system of FIG. 1.

FIG. 3 is a simplified flow diagram of the operation of an implementation of the stabilization system of FIG. 1.

FIG. 4 is a detailed flow diagram of the operation of an implementation of the stabilization system of FIG. 1 according to one embodiment.

FIG. 5 is a detailed flow diagram of the operation of an implementation of the stabilization system of FIG. 1 according to another embodiment.

### DETAILED DESCRIPTION

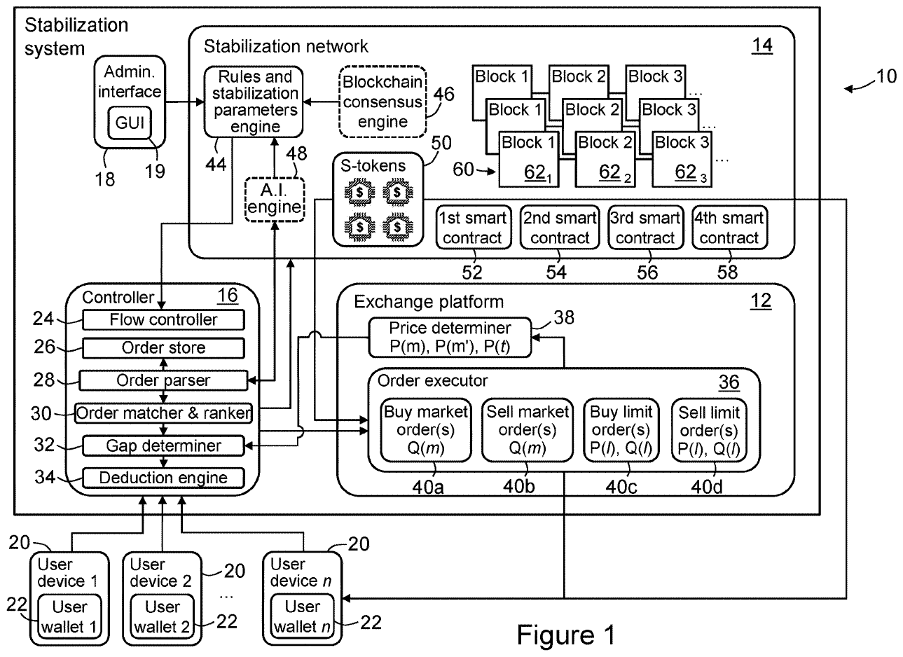

FIG. 1 is a schematic architectural view of a stabilization system 10 according to an embodiment of the present invention. System 10 includes a first layer in the form of an asset trade or exchange platform 12, a second layer in the form of a stabilization network 14, a controller 16, and an administrator interface 18 (for use by an administrator) which implements a GUI 19. Exchange platform 12 has a centralized network architecture (comprising, for example, a centralized server or networked servers). Stabilization network 14 has a decentralized network architecture. System 10 thus integrates exchange platform 12, with a centralized network architecture so high efficiency/response rate, and stabilization network 14, with a decentralized network architecture so high stability/reliability, such that system 10 can be both highly responsive and reliably stable.

It will be noted that stabilization network 14 is depicted and described below as a single computing device, but it will be understood that it in fact comprises distributed computing devices that host one or more distributed ledgers for storing blockchains.

System 10 is adapted to facilitate the exchange (viz. buying and selling) of assets such as shares, securities, coins, etc., and to do so in a manner that manages the gap G between supply and demand in an asset market in a consistent manner, so as to reduce the volatility of the price of that asset while maintaining the role of the gap in leading to changes in the asset's price. The following, however, describes the application of system 10 to the exchange of assets in the form of shares, without loss of generality.

Thus, system 10 is shown in FIG. 1 with user computing devices 20, controllable by respective share traders 1, 2, . . . , n (individuals or institutions) to transmit control signals to controller 16 of system 10; the control signals are indicative of buy and sell orders in respect of those shares that can be bought or sold using system 10. The control signals each identify the share of interest and, as described in detail below, parameters indicative of a buy order or a sell order. Each of the user computing devices 20 has a respective user digital wallet 22.

Controller 16 includes a flow controller 24, an order store 26, an order parser 28, an order matcher and ranker 30, a gap determiner 32 that is configured to determine the gap G between share supply and demand (described below), and a deduction engine 34 that is configured to determine and apply deductions (as also described below). Controller 16 is configured to—during each preset time window of duration T (beginning at time t)—receive the orders indicated by the control signals received during the instant time window, to control order parser 28 to extract key parameters of each order (including the identity of the shares to be bought or sold, the number of shares to be bought or sold, whether the order is a buy order or a sell order, whether the order is a market order or a limit order, and—in the case of limit orders—the price identified in the limit order), and to rank sell limit orders ascending by price limit, buy market orders ascending by quantity, buy limit orders descending by price limit and sell market orders ascending by quantity. Order parser 28 is also configured to save the orders to order store 26, and to pass the ranked orders to order matcher and ranker 30.

[Note: Conventionally, a buy market order comprises an order to buy a number Q(m) of a specific share at the current market price P(m) of those shares; a sell market order comprises an order to sell a number Q(m) of a specific share at the current market price P(m) of those shares; a buy limit order comprises an order to buy a number Q(l) of a specific share as soon as those shares becomes available (i.e. at a present or future time) at a price at which that price is at or below a specified maximum price limit P(l); a sell limit order comprises an order to sell a number Q(l) of a specific share as soon as a buyer becomes available (i.e. at a present or future time) that will pay a price that is at or above a specified minimum price limit P(l).]

Controller 16 is configured to respond to the closing of the instant time window by controlling order matcher and ranker 30 to match ranked sell limit orders and buy market orders, and to match buy limit orders and sell market orders, and to pass the matched orders to gap determiner 32. Gap determiner 32 is configured to determine—for each matched pair of orders—the size, if any, of the gap G between supply and demand.

Flow controller 24 defines a set of rules and stabilization parameters according to which controller 16 controls exchange platform 12 and stabilization platform 14, including whether stabilization platform 14 is to become active in the processing of the orders following the closing of the instant time window.

Deduction engine 34 is configured to determine whether a deduction should be applied to the order (according to the aforementioned rules and stabilization parameters) and, if it determines that a deduction should be applied, determines and applies the appropriate deduction to the order. Deduction engine 34 operates as follows.

In general, in case of excess demand, cash will be deducted from the buyers, while in the case of excess supply, assets will be deducted from the sellers.

In the case of excess demand, the seller asks for a limit-price P(l)>P(m) and a quantity Q(l), and expects to receive an amount of money as remuneration equal to V(l)=P(l)·Q(l). The exchanged quantity will be the minimum of the limit-order and the market order quantities. (For simplicity, the minimum quantity is denoted by Q(l).) However, the price will be the adjusted or stabilized price, P(m′). Hence, the buyer pays V(l)=P(l)·Q(l), but the seller receives V(m′)=P(m′)·Q(l)<V(l). Deduction engine 34 determines the difference V(l)−V(m′)=Q(l)·(P(l)−P(m′)) to be deducted from the buyer, applies that deduction to the order and deposits the deduction in the stabilization fund of stabilization network 14. The specific deduction is controlled by a series of stabilization parameters (discussed below), including most pertinently at least one throttling parameter generally represented herein as θ.

To compensate the seller, the stabilization fund issues S-tokens equal in value to V(l)−V(m′). The buyer also needs to be compensated, as he or she now receives a quantity of the asset the value of which is V(m′), which is less than the money paid by the buyer. Hence, the same number of S-tokens should be issued to the buyer by stabilization network 14. The result is that the total S-tokens are covered only by 50% of their (book) value.

In the case of excess supply, the buyer asks for a limit-price P(l)<P(m) and quantity Q(l). The seller is offering the quantity Q(m) at whatever price. As there is an excess supply, the deduction determined by deduction engine 34 will be applied by deduction engine 34 to the asset. Deduction engine 34 determines the deduction as follows.

First, deduction engine 34 receives the stabilized price, P(m′)>P(l) (from price determiner 38: see below). The buyer is willing to pay V(l)=P(l)·Q(l) (where Q(l) is the minimum of quantities of the market and limit orders), so deduction engine 34 calculates the quantity that produces the same V(l) at the stabilized price: Q(m′)=V(l)/P(m′), where Q(m′)<Q(l). This is the quantity that will be delivered to the buyer. Hence, the buyer receives Q(m′) at price P(m′), with a total value of V(l)=V(m′)=P(m′)·Q(m′).

The seller on the other hand delivers Q(l) but receives money V(m′), which reflects the value of a smaller quantity of the asset, Q(m′)<Q(l). The seller therefore needs to be compensated, so stabilization fund 14 issues he or she is issued S-tokens equivalent in value to P(m′)·(Q(l)−Q(m′)).

Although the buyer receives a quantity of the asset at a price that produces the same value that the buyer was willing to pay without stabilization, the buyer receives a smaller quantity at a higher price. The buyer will not be entirely satisfied because the opportunities for future profits are now lower: the buyer gave up a quantity equal to Q(l)−Q(m′) at the new market price of P(m′). Hence, the buyer is compensated by S-tokens equivalent in value to P(m′)·(Q(l)−Q(m)), which is the same as that of the seller.

These various parameters and formulae are summarized in Table 1.

TABLE 1
Stabilization Formulae

| | Excess Demand: | | Excess Supply: | |
|---|---|---|---|---|
| | net buy market orders | | net sell market orders | |
| Properties | P(m′) < P(I) | | P(m′) > P(l) | |
| | Q(m′) = Q(l) | | Q(m′) < Q(I) | |
| Agent | Buyer | Seller | Buyer | Seller |
| Pays/delivers | $V(l) | Q(l) | $V(l) | Q(l) |
| Receives | Q(l) + N S- | $V(m′) + N S- | Q(m′) + N S- | $V(l) + N S- |
| | tokens | tokens | tokens | tokens |

| | | |
|---|---|---|
| Deduction | Cash = $V(l) - $V (m′) | Quantity = Q(l) - Q(m′) |
| S-tokens | Q(l) · (P(l) - P(m′)) = | P(m′) · (Q(l) - Q(m′)) = |
| value | V(l) - V(m′) | V(m′) - V(l) |
| (one-sided) | | |

| | |
|---|---|
| Number of S-tokens | $N = \frac{\vert V ( l ) - V ( {m}^{′} ) \vert}{P ( s )}$ |

Notes
V(I) = P(l)Q(l)
V(m′) = P(m′) · Q(l)
P(m′) = θ · P(m) + (1 - θ)P(l)

(Note that Table 1 includes step as well as smooth functions, each with suitable adjustments of the notations: see below.)

Controller 16 is configured to direct orders that do not attract a deduction to exchange platform 12. Controller 16 is configured to split orders that attract a deduction into two components: (i) the order once the deduction has been applied, and (ii) the deduction; controller 16 is configured to direct the first component to exchange platform 12, and to direct the second component to stabilization platform 14 (for storing in the stabilization fund).

More specifically, the rules and stabilization parameters of flow controller 24 stipulate that controller 16 direct orders received in the instant closed window to control exchange platform 12 and stabilization network 14 for processing. These rules and stabilization parameters are as follows:
Rule 1: at or below a predefined first threshold in the absolute magnitude of the gap G between supply and demand, controller 16 controls exchange platform 12 to process all orders without invoking stabilization network 14 (as described below);
Rule 2: above the first threshold and at or below a predefined second threshold in the gap G between supply and demand, controller 16 controls exchange platform 12 to process the orders and invokes stabilization network 14 to perform a portion of the processing of the orders (as described below);
Rule 3: above the second threshold in the gap G between supply and demand, controller 16 controls exchange platform 12 to process the orders and invokes stabilization network 14 to perform a greater portion of the processing of the orders (as described below).

The gap G between supply and demand may be defined in any suitable way consistent with the notion of a ‘gap’ (or difference). In this embodiment, for example, gap G is defined to be the absolute magnitude of the percentage difference between market price and price limit, that is:

G=|P(m)−P(l)|/(max(P(m),P(l))).

The absolute value in the numerator makes this definition of G suitable for both sell or buy limit orders, i.e., regardless of which of P(m) and P(l) is greater, such that G≥0. Setting the denominator as the maximum of either P(m) or P(l) ensures that G<1.

In other embodiments, the gap G might be defined, for example, as G=|P(m)−P(l)|/P(m), or as G=|P(m)−P(l)|/P(l), or as G=|P(m)−P(l)|, with corresponding changes to other parameters where required.

These rules are implemented by controller 16 according to the following stabilization parameters:
Stabilization parameter 1: defines the first threshold, which is represented herein as α₀, where 0≤α₀<1 (e.g. 3%);
Stabilization parameter 2: defines the second threshold, which is represented herein as α₁, where α₀<α₁≤1 (e.g. 50%);
Stabilization (or ‘first throttling’) parameter 3a: defines the degree of intervention of stabilization network 14 (and hence the degree of throttling of exchange platform 12) when the gap G is within the limits α₀≤G<α₁, and is represented herein as θ₀, where 0<θ₀≤1 (e.g. 3%);
Stabilization (or ‘second throttling’) parameter 3b: defines the degree of intervention of stabilization network 14 when the gap G≥α₁, and is represented as θ₁, where θ₀<θ₁≤1 (e.g. 99%);
Stabilization parameter 4: defines the duration of the order accumulation window T (e.g. 30 s or 60 s);
Stabilization parameter 5: governs the minimum redemption period of the S-tokens (e.g. 18 months (viz. from the date of issuance)), after which the owner can redeem the S-tokens from the stabilization fund;
Stabilization parameter 6: governs the minimum trade period of the S-tokens (e.g. 12 months (viz. from the date of issuance)), after which the owner can trade the S-tokens with other owners (such that the trade can be executed e.g., either through the centralized network, or through the decentralized network, and—in either case—is not subjected to the stabilization parameters because it is already part of the stabilization network);
Stabilization parameter 7: governs the interference of system 10 as a Stabilizer of Last Resort, as described below.

Any one or more of these parameters (in particular parameters 1, 2, 3a and 3b) can be constants. Also, any one or more of these parameters can be functions of the magnitude of the flow of control signals, of the content of the control signals, or of other variables of system 10, or of combinations thereof (in particular parameters 3a, 3b).

It will also be appreciated that other rules and stabilization parameters may be implemented. For example, alternative Rule 2′ may replace the above Rules 2 and 3 (with no stabilization parameter 3a or 3b):

Rule 2′: above the first threshold in the gap G between supply and demand, controller 16 controls exchange platform 12 to process the orders and invokes stabilization network 14 to perform a portion of the processing of the orders (essentially the equivalent of setting α₁=1).

The rules and stabilization parameters are initially set by the administrator of system 10 via administrator interface 16. Subsequently, they can be modified, such as by the administrator or based on the consensus of the traders.

Exchange platform 12 includes an order executor 36 configured to execute the orders, and a price determiner 38. To facilitate the execution of the orders (by carrying out a trade), order executor 36 is provided by controller 16 with the order parameters extracted from the orders submitted—in a respective order window—by the users of user devices 20. Consequently, order executor 36 typically receives in parsed form one or more buy market orders 40a (each including a number of shares Q(m) desired to be bought), sell market orders 40b (each including a number of shares Q(m) desired to be sold), buy limit orders 40c (each including a number of shares Q(l) desired to be bought and a price limit P(l)), and sell limit orders 40d (each including a number of shares Q(l) desired to be sold and a price limit P(l)).

Price determiner 2 is configured to receive order and trade data from order executor 36, and for any particular share to determine (from existing orders) the current price P(m) at time t, the new price P(m′) of that share after each subsequent trade in that share has been executed by order executor 36, and the price (or value) of an S-token P(t) at time t.

Stabilization network 14, which is in data communication with controller 16 and exchange platform 12, includes a rules and stabilization parameters engine 44 that establishes or accesses the rules and stabilization parameters discussed above, and passes them to flow controller 24.

Stabilization network 14 optionally includes a blockchain consensus engine 46 that implements user-consensus decisions determining the rules regulating the S-token and the rules concerning market interference by system 10 as a Stabilizer of Last Resort. The users in this context are typically the traders that use system 10.

Stabilization network 14 also optionally includes an Artificial Intelligence (A.I.) engine 48 configured to improve the overall functionality of system 10 by enhancing the determination of the stabilization parameters. To this end, A.I. engine 48 communicates with order parser 28 and with rules and stabilization parameters engine 36. For example, A.I. engine 48 can learn from how changes in the stabilization parameters (especially θ₀ and θ₁) affect the performance—and in particular the stability—of system 10, and can respond by determining a change in the values of those parameters (such as to increase or decrease θ₀ and/or θ₁) that will increase or maximize the stability of system 10. A.I.) engine 48 then transmits the modified values of the parameters to order parser 28 and/or stabilization parameters engine 36 as appropriate.

Administrator interface 18 is configured to communicate with rules and stabilization parameters engine 44, and is controllable by a system administrator to set or modify the rules and stabilization parameters.

Stabilization network 14 includes an S-token blockchain database 50 (recording the S-tokens and cash held as the stabilization fund by system 10), and first, second, third and fourth smart contracts 52, 54, 56, 58, which respectively define a buy market order, a sell market order, a buy limit order and a sell limit order implementable by system 10. Stabilization network 14 also includes blockchains (of which blockchain 60 comprising blocks 621, 622, 623, . . . , is an example), which record the transactions implemented by system 10, including the buying of shares, the selling of shares, and the transfer (as a deduction from a share purchase or sale) of cash or shares to the stabilization fund maintained by system 10 in, or maintained by, stabilization network 14.

The flow of the processing of orders is controlled in such a manner that the response rate of exchange platform 12 remains as close as possible to that of a conventional exchange platform (i.e. one without stabilization components), but the type of response differs according to the magnitude and nature of those orders. Hence, the control signals are configured to control exchange platform 12 to perform a first set of actions (as described below) but, as this flow increases, a fraction or percentage of the flow, θ, is diverted from exchange platform 12 to stabilization network 14. The control signals instead diverted to stabilization network 14 control stabilization network 14 to perform a second (and different) set of actions (also as described below). Thus, the diversion of control signals (according to the stabilization parameters) acts as a throttle between exchange platform 12 and stabilization network 14, variously increasing or relieving the demand or supply on exchange platform 12 to respond to the control signals.

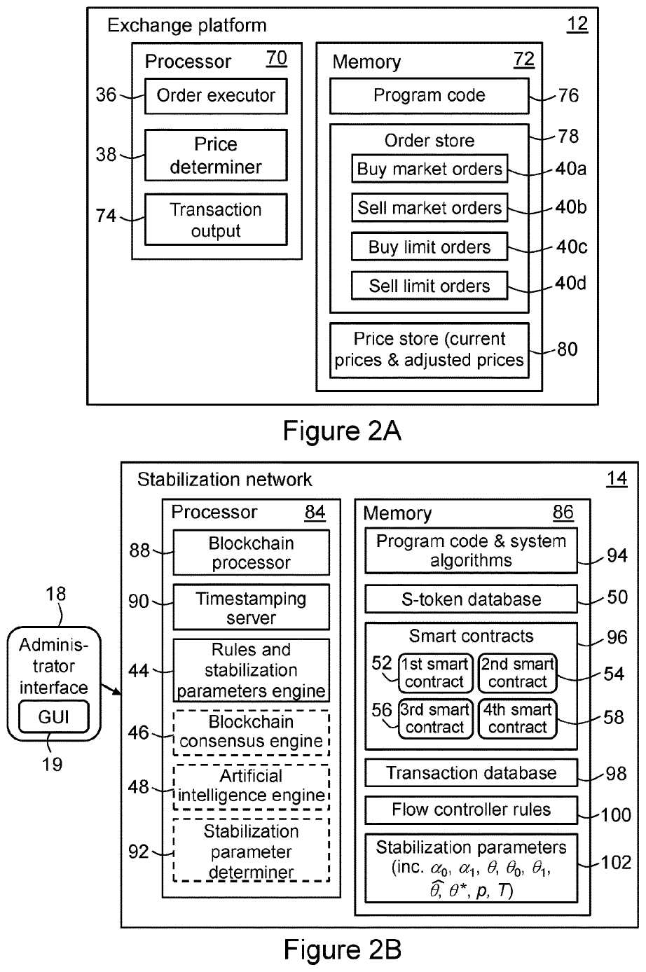

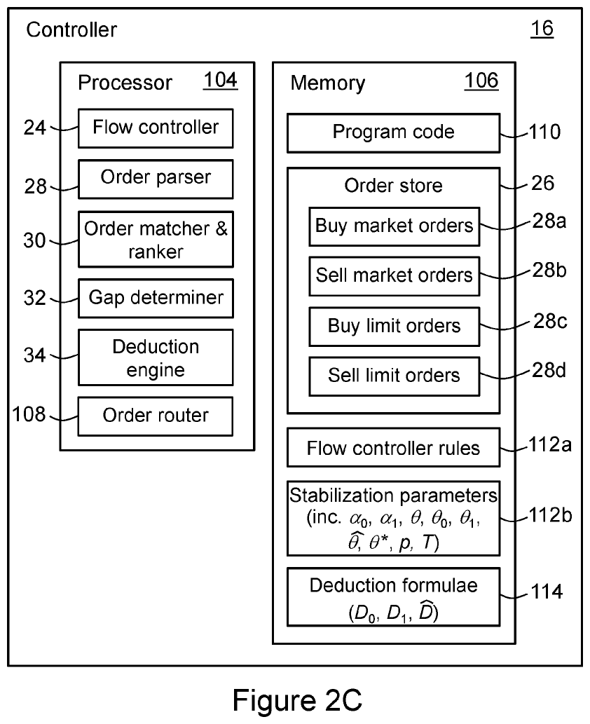

FIGS. 2A, 2B and 2C are schematic architectural views of, respectively, exchange platform 12, stabilization network 14 (with administrator interface 18) and controller 16. Referring to FIG. 2A, exchange platform 12 includes a processor 70 and memory 72. Processor 70 includes the aforementioned order executor 36 and price determiner 38, and a transaction output 74 configured to output relevant details of each trade executed by exchange platform 12 to stabilization network 14 and to the user wallets 22 of the parties to a respective trade, after the completion of that trade.

Exchange platform 12 typically includes both volatile and non-volatile memory and more than one of each type of memory, with such memories collectively represented by memory 72, which is in data communication with the processor 70. Memory 72 includes program code 76 for controlling the operation of processor 70, an order store 78 for receiving and storing the buy market orders 40a, sell market orders 40b, buy limit orders 40c and sell limit orders 40d, and a price store 80 for storing current prices and adjusted prices.

Referring to FIG. 2B, stabilization network 14 includes a processor 84 and memory 86 (which likewise typically comprises both volatile and non-volatile memory and more than one of each type of memory) in data communication with processor 84. Processor 84 includes a blockchain processor 88 and a timestamping server 90 which perform the functions required to process blocks and maintain that part of the distributed ledger of S-tokens and smart contracts stored in stabilization network 14.

Processor 84 also includes the aforementioned rules and stabilization parameters engine 44, blockchain consensus engine 46 and A.I. engine 48, and optionally a stabilization parameter determiner 92, configured to determine the stabilization parameters (and in particular α₀, α₁, θ₀, and θ₁) dynamically when controlled to do so by administrator interface 18.

Memory 86 stores program code and system algorithms 94 (to control operation of the processor 84), the aforementioned S-token blockchain database 50 (which stores the S-tokens of system 10), smart contract blockchain database 96 (storing 1st to 4th smart contracts 52, 54, 56, 58), transaction blockchain database 98 (which stores executed transactions, such as in the form of blockchain 60), flow controller rules 100 (which mirrors the flow controller rules of flow controller 24) and stabilization parameters (inc. α₀, α₁, θ₀, θ₁, p and T) 102 (which mirrors the stabilization parameters of flow controller 24).

Referring to FIG. 2C, controller 16 includes a processor 104 and memory 106 (which, again, typically comprises both volatile and non-volatile memory and more than one of each type of memory) in data communication with processor 104. Processor 104 includes the aforementioned flow controller 24, order parser 28, order matcher and ranker 30, gap determiner 32 and deduction engine 34. Controller 16 also includes an order router 108, configured to direct orders (or components thereof) to exchange platform 12 and/or stabilization network 14, based on whether a deduction has been applied by deduction engine 34.

Thus, as discussed above, exchange platform 12 executes trades of the asset (e.g. share or stablecoin) for money. Stabilization network 14 sets the stabilization policy parameters (including α₀, α₁, θ₀, and θ₁). These parameters are set primarily by consensus by the blockchain network users (i.e. the traders), with possible input from optional A.I. engine 48 and administrators via administrator interface 18. Stabilization network 14 also manages the issuance of S-tokens in exchange for deductions of assets trade orders (discussed below).

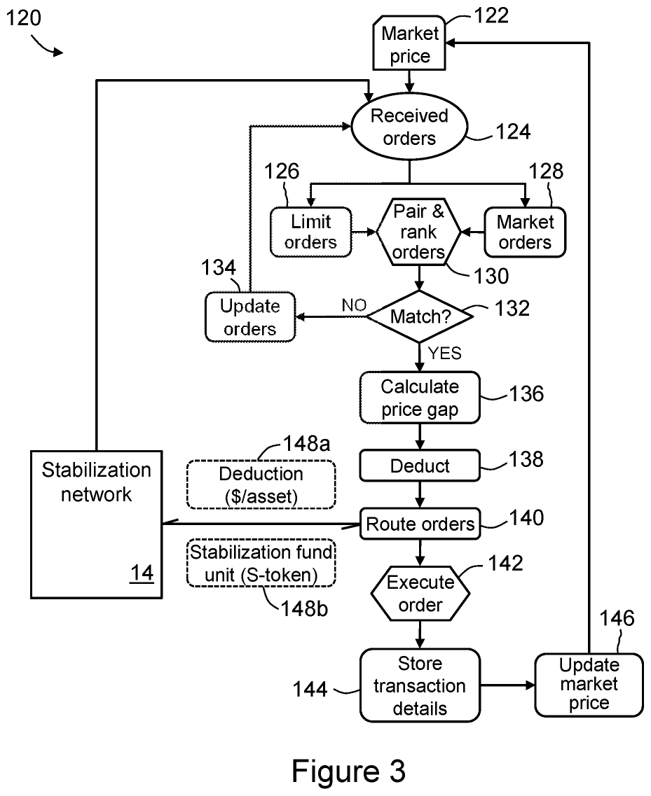

Broadly, system 10 operates as shown schematically in flow diagram 120 of FIG. 3. At step 122, a market price is set or accessed by price determiner 38 (such as on the basis of past trades). At step 124, controller 16 receive orders for trades of the asset from user devices 20), and—at step 126—order parser 28 resolves the orders, in particular into limit orders and market orders. At step 130, order matcher and ranker 30 pairs any matching buy-market-orders and sell market orders and ranks the remaining orders. At step 132, order matcher and ranker 30 matches—according to rank—respective sell limit orders and buy market orders and matches—according rank—respective buy limit orders and sell market orders.

If order matcher and ranker 30 finds no orders to match, processing continues at step 134, where a new tranche of orders is received or identified for processing.

If order matcher and ranker 30 finds orders to match, processing continues at step 136, where gap determiner 32 determines the gap G between each pair of the remaining matched buy and sell orders based on Rules 1 to 3 (see above) as the absolute percentage difference between the price limit and the market price (see definition above).

At step 138, deduction engine 34 determines what if any deduction should be applied and applies that deduction, in this embodiment as follows:
For matched orders where G≤α₀, no deduction is applied;
For matched orders where α₀<G≤α₁, deduction engine 34 of controller 16 applies a first deduction formula (the form of which depends on the type of order) to the matched orders and thereby determines a first deduction D₀, which deduction engine 34 applies to the excess side (either supply or demand) order, then splits each of such matched orders into two parts:
   (i) a deducted order (being the excess order from which the determined first deduction has been applied) and a non-deducted order (the non-excess order); and
   (ii) the determined first deduction.
For matched orders where G>α₁, deduction engine 34 applies a second deduction formula (the form of which depends on the type of order) to the matched orders and thereby determines a second deduction D₁, which controller 16 applies to the matched orders, then splits each of such matched orders into two parts:
   (i) a deducted order (being the excess order from which the determined second deduction has been applied) and a non-deducted order (the non-excess order); and
   (ii) the determined second deduction.

In this embodiment, the first deduction formula is as follows:

$${D}_{0} = \{ \begin{matrix}V ( l ) - V ( {m}_{0}^{′} ) , for matched buy market orders and sell limit orders ( excess demand ) \\ Q ( l ) - Q ( {m}_{0}^{′} ) , for matched buy limit orders and sell market orders ( excess supply )\end{matrix}$$

where V(l)=P(l). Q(l), P(l) and Q(l) are the price limit and the quantity limit, respectively. V(m₀′)=P(m₀′) Q(l); Q(m₀′)=V(l)/P(m₀′); P(m₀′)=θ₀P(m)+(1−θ₀). P(l), and θ₀ (e.g., 3%) is stabilization (or ‘first throttling’) parameter 3a.

In this embodiment, the second deduction formula is as follows:

$${D}_{1} = \{ \begin{matrix}V ( l ) - V ( {m}_{1}^{′} ) , for matched buy market orders and sell limit orders ( excess demand ) \\ Q ( l ) - Q ( {m}_{1}^{′} ) , for matched buy limit orders and sell market orders ( excess supply )\end{matrix}$$

where P(m)=θ₁P(m)+(1−θ₁). P(l), and θ₁ is stabilization (or ‘second throttling’) parameter 3b (with the other parameters as defined above with suitable replacement of m₀′ with m₁′).

It should be noted that, in other embodiments, a single deduction formula, or alternative first and/or second deduction formulae, or more than two deduction formulae, may be employed. In all embodiments, however, the stabilized price falls into the range from the market price to the limit price, and the deductions are configured to reduce the gap and therefore to reduce price changes.

In other embodiments, a single throttling parameter and a single deduction formula may be employed. For example, the throttling parameters and deduction formulae of the present embodiment may be expressed in other embodiments by defining a single throttling parameter \hat{θ} of the following form:

$$\hat{θ} = \{ \begin{matrix}0 , if G \leq {α}_{0} \\ {θ}_{0} , if {α}_{0} < G \leq {α}_{1} \\ {θ}_{1} , if G > {α}_{1}\end{matrix}$$

where θ₀ and θ₁ in this embodiment are constants. Hence, a single deduction \hat{D} for all values of G may then be employed by using a deduction formula as follows:

$$\hat{D} = \{ \begin{matrix}V ( l ) - V ( {\hat{m}}^{′} ) , for matched buy market orders and sell limit orders ( excess demand ) \\ Q ( l ) - Q ( {\hat{m}}^{′} ) , for matched buy limit orders and sell market orders ( excess supply )\end{matrix}$$

Where the stabilized price now is defined in terms of \hat{θ}, such that

P(\hat{m}′)=\hat{θ}·P(m)+(1−\hat{θ})·P(l).

However, in still further embodiments, the throttling parameter may be defined as a function that varies continuously over some or all values of G (such as, in particular, when G>α₀=5%). For example, in certain embodiments, first and second throttling parameters are defined such that:

$${θ}_{1} = {G}^{{θ}_{o}} , where 0 < {θ}_{0} < 1 .$$

Parameter θ₀ determines the curvature of θ₁ over G, so indicates by how much θ₁ exceeds the gap within the unit interval. As θ₀ lies between 0 and 1, θ₁ cannot exceed 1. In this example, the throttling parameter θ* implemented by system 10 is then defined by:

$${θ}^{*} = \{ \begin{matrix}0 , if G \leq {α}_{0} \\ {θ}_{1} , if G > {α}_{0}\end{matrix}$$

For example, if G=3% and α₀=5%, G<α₀, so θ*=0. However, if G=9%, α₀=5% and θ₀=0.75, the throttling parameter θ*=16.4%—so 16.4% of the gap will be deducted. As before, however, in all cases, the stabilized price falls into the range from the market price to the limit price, and the deductions are configured to reduce the gap and therefore to reduce price changes. The two parameters, θ₀ and α₀, can be adjusted to the desired level of volatility of the environment. For example, for a stablecoin where volatility must be tightly controlled, θ₀ and α₀ will have relatively low values. In a more flexible environment like the stock market, they will have relatively high values.

Referring to FIG. 3, at step 140, order router 108 of controller 16 routes the orders (or components thereof) to exchange platform 12 and/or stabilization network 14, as follows:
Order router 108 routes paired buy market orders and sell market orders to exchange platform 12.
Order router 108 routes matched sell limit orders and buy market orders, and matched buy limit orders and sell market orders, with no deduction (i.e. with a gap G≤α₀) to exchange platform 12.
In the case of orders in which a deduction has been determined to be applicable, order router 108 routes the deducted order and the non-deducted order to exchange platform 12, and routes the determined deduction (whether first or second) to stabilization network 14.

At step 142, order executor 36 of exchange platform 12 executes the orders, and at step 144 price determiner 38 updates the market price. At step 144, details of each transaction are stored in a blockchain in transaction database 98 and communicated to the user wallet 22 of the parties to the respective transaction. Processing for the instant tranche of orders then ends.

Note that the deduction 148a (whether cash or asset(s))—routed by order router 108 to stabilization network 14—is deposited in the stabilization fund, and the user (buyer or seller) that has surrendered that deduction is issued S-tokens 50 by blockchain processor 88 of stabilization network 14, that is, units 148b in the stabilization fund of corresponding value (such as the book value of that asset). As a consequence, those units represent his or her share of the stabilization fund arising from that deduction.

Thus, system 10 tempers price volatility by reducing the gap between supply and demand by (i) deducting from the gap between market orders, and (ii) deducting from the limit orders that match the limit of the opposite side of the market. Additionally—in this example—system 10 can temper price volatility by maintaining and managing the stabilization fund, held in a blockchain (e.g. blockchain 60 of stabilization network 14), so as to act as a “Stabilizer of Last Resort” (see below) within the limits of the stabilization fund's accumulated cash and asset resources.

Matched limit orders are effectively market orders. Accordingly, the gap in overall market orders indicates the pressure on price movements. By deducting a portion of such a gap, the pressure on price can therefore be contained. This deduction is compensated by S-tokens.

The S-tokens, units of the stabilization fund, cannot be traded for a predefined period p (e.g. 2 or 3 years) in order to preserve the role of system 10 in reducing volatility. The S-tokens may therefore be described as a ‘forced savings’ for investors. Investors allocate a portion of their demand or supply to the stabilization fund, and cannot use it or cash it in for that predefined period p.

The stabilization fund is managed according to the following two scenarios:
1. In normal times, the stabilization fund's assets are held passively. The stabilization fund may distribute a portion (say 30%) of its assets every 2 to 3 years to investors.
2. In major turmoil, the stabilization fund can intervene to actively stabilize the market, such as by buying shares during a downturn and/or selling shares during a bubble. Hence the stabilization fund can play the role of “Stabilizer of Last Resort.”

### System Parameters

To employ system 10, the stabilization parameters are tuned to the stablecoin, such as by—initially—setting the stabilization parameters (in particular α₀, α₁, θ₀, and θ₁) according to the results of simulations, but then subsequently adjusting them with A.I. engine 48.

For example, system 10 may use α₀=0.1% and α₁=2%, which would mean that fluctuations in price less than or equal to 0.1% will not be subjected to a deduction. Fluctuations greater than 0.1% but less than or equal to 2% are subjected to a deduction at a rate of 00. However, when demand or supply exceeds the other by more than α₁ (in this example 2%), the excess is subject to a deduction rate of θ₁>θ₀, such as θ₁=0.99. This high deduction ratio aims to stabilize the price of the coin.

It might seem harsh or excessive to deduct all or most of the excess supply or demand beyond α₁, but it should be noted that a purpose of the stablecoin is to serve as a medium of exchange of goods and services. The stability of the stablecoin therefore supersedes the flexibility of the exchange for dollars. Users, knowing that all or most of the excess supply or demand beyond 2% will be replaced by stabilization fund units, will have cause to be confident in the stability of the stablecoin, so will not be encouraged to approach the currency exchange market (i.e. to replace the stablecoin with currency such as dollars for use in buying goods) but rather use the stablecoins in the goods market.

As pointed out above, these parameters need not be constants. They could be formulated as functions to adjust to market conditions as needed. The adjustment process may depend, inter alia, on Artificial Intelligence.

### Fund Parameters

Fund units for the stablecoin have their own parameters. Each unit will be restricted from being traded or transferred for a certain period. After that period, units are open to trade or redemption to underlying dollars and stablecoins.

Fund management can decide how much of each unit will be unrestricted, and to which asset. For example, the Fund might decide, for units issued 1 year before, to unrestrict 50% of each unit to dollars only, or to coins only, or to both. These parameters can be decided in a manner that helps to manage the stability of the stablecoin.

Thus, system 10 does not employ a conventional fund. Instead, system 10 manages assets with the blockchain-based stabilization network 14 for asset management. The benefits of blockchain technology are well established. Meanwhile, the transactions of stabilization network 14 do not need high-speed systems (as employed by exchange platform 12). Hence, the verification process of the blockchain can be done without time pressure.

System 10 may be funded by the aforementioned deductions, received from transactions made through exchange platform 12. These deductions are in cash or assets (see above), and compensated for in S-tokens. Two important consequences of stabilization network 12 are as follows.

S-tokens represent quasi-shares in the assets of system 10 resulting from these deductions. An S-token has a number of advantages over conventional “fund units”:
1. The S-tokens are restricted from being traded or redeemed for a predefined period (e.g. a number of years or months) defined by stabilization parameters 6 and 7. Such restrictions are intended to provide stability. Unlike standard fund units, the restrictions can be easily enforced on the S-tokens through smart contracts and verified by stabilization network 14.
2. If users wish to adjust or amend the rules regulating the S-token, the users can adopt a consensus strategy (e.g., a simple voting system) to amend the rules, via Blockchain consensus engine 46, such that the users have a degree of control over the rules of trading the S-tokens.

It will be noted that the stabilization fund can provide an additional layer of stabilization in case of turmoil by actively participating in the market. Through the blockchain technology, users can decide when and how the fund should interfere in the market as a Stabilizer of Last Resort. Again, system 10 can implement a suitable consensus strategy (or majority rule) to make the necessary decisions.

Stabilization network 14 provides two important benefits for system 10:
1. Stabilization network 14 offers a trusted layer of protection to exchange platform 12 and system 10. If system 10 aims to stabilize exchange platform 12, and therefore to protect it, then stabilization network 14 aims to protect both exchange platform 12 and hence system 10. The interaction between exchange platform 12 and stabilization network 14 is synergistic.
2. Stabilization network 14 provides users with a reliable mechanism to manage exchange platform 12 and make the critical decisions concerning stabilization of the market. As users contribute the deductions, they collectively own the assets of exchange platform 12, so they can be given the ability to manage those assets. Stabilization network 14 provides a decentralized mechanism for managing these assets (rather than having decisions made centralized by, for example, a third-party).

In greater detail, system 10—as applied to the trade of shares, cryptocurrencies, or any other tradable asset—operates as follows. (The exchange of other tradeable assets will differ in detail, but such variations can be readily accommodated.)

Orders received by controller 16 from user devices 20 are typically of two types: market orders and limit orders. The market price changes in response to the interaction between these two types of order.

### Ranking and Matching

After order parser 28 has parsed and flagged received orders into their respective types, order parser 28 passes the orders to order matcher and ranker 30. Order matcher and ranker 30 identifies and pairs matching buy-market-orders and sell-market-orders: the resulting pairs, if any, constitute trades that controller 16 forwards to exchange platform 12 for execution without other processing.

Order matcher and ranker 30 then ranks any remaining received limit orders before matching them with market orders. Order matcher and ranker 30 ranks sell limit orders in ascending order. This is so that a sell-order limited by, say $80, means the seller wants $80 or more. A sell-order limited by $100 will require $100 or more. Hence, by starting with the lowest limit, greater scope is provided for the trade to take place. If the amount (viz. number of shares, etc.) decided by the $80 limit order is sold, exchange platform 12 moves to the next limit order, and the price (after matching and execution) therefore increases.

Order matcher and ranker 30 ranks buy limit orders in descending order, for effectively the same reason.

Order matcher and ranker 30 passes the ranked orders to order matcher and ranker 30.

For each of the ranked limit orders, order matcher and ranker 30 checks market orders on the other side of the trade. That is, for sell limit orders, order matcher and ranker 30 checks buy market orders, and vice versa. Market orders accept the best available price and, as the limit orders have been ranked by order matcher and ranker 30, order matcher and ranker 30 can then readily match the orders- and pass the matched orders in pairs to gap determiner 32.

### Gap Between Supply and Demand

Gap determiner 32 determines, for each pair of ranked matched orders, the gap G between supply and demand and, on the basis of that gap G, deduction engine 34 determines whether a deduction should be applied to the corresponding trade (i.e. arising from the matched pair of orders) and, if so, the size and manner of that deduction. The orders are then sent to exchange platform 12 and/or stabilization platform 14.

The procedure is applied every period T (for example, every 30 or 60 s), either predefined or determined by exchange platform 12 but enforced by controller 16. During each of these periods, orders are collected by controller 16 and then processed according to the process below.

Once the orders are collected, order matcher and ranker 30 of controller 16 groups market orders (whether sell or buy orders), then matches grouped sell and buy orders where possible. Order router 108 either flags the matched orders for later transmission to exchange platform 12 (such as with other orders in the instant tranche of orders), or transits them immediately, for execution by exchange platform 12 executes the matched orders. Note that the execution of market orders does not affect the current market price (which is taken to be the price of the most recent executed transaction, so recorded in system 10).

Order matcher and ranker 30 checks whether there are any remaining (i.e. unmatched) market orders, that is, sell market orders that were not matched with buy orders (having no identical counterpart or counterparts) or vice versa. If no unmatched market orders remain, processing stops until the next session (i.e. of duration T).

If order matcher and ranker 30 determines that there are such remaining (i.e. unmatched) market orders, then these could be either buy-market-orders (this the case of excess demand) of sell-market-orders (excess supply). In case of excess demand, order matcher and ranker 30 ranks buy-market-orders by quantity in ascending order and ranks sell-limit-order by price in ascending order. Order matcher and ranker 30 creates a table with two columns: a first column of buy-market-orders and a second column of sell-limit-orders.

Starting from the first row, order matcher and ranker 30 checks the price limit against the current market price. (It is assumed that the quantity of the limit order is the same as that of the market order, Q(l). If not, exchange platform 12 can be configured to permit fractional or partial fulfillment of orders, with Q(l) being the lower of the two quantities, Q(l) and Q(m).)

The sell-limit-price P(l) will be higher than the current market price P(m) by a quantity as follows. If the price gap G (defined above) is such that G≤α₀, where 0≤α₀≤1, then the gap between P(l) and P(m) is within the acceptable range, so exchange platform 12 applies no deduction, and processing proceeds as usual.

However, if the price gap G is such α₀<G≤α₁, then exchange platform 12 applies a deduction (calculated using θ₀ described above) to reduce the gap between the desired price and the current market price. The stabilized price becomes:

P(m₀′)=θ₀P(m)+(1−θ₀)P(l)

That is, the stabilized price will be a weighted average of the current market price and the limit price. This formula ensures that the deduction applies only to the difference between P(m) and P(l). This can be shown by noting that:

P(m₀′)=P(m)+(1−θ₀)(P(l)−P(m))=θ₀P(m)+(1−θ₀)P(l).

In case of excess demand, P(m)<P(l), so we add the net difference between limit and market price, after deduction, to P(m), to obtain the new market price P(m₀′). With rearrangement, we obtain the formula above.

The buyer pays V(l)=P(l)·Q(l) in cash and receives a quantity Q(l) of the asset (e.g., shares). The new market price P(m₀′) will be lower than P(l) (see below), so the buyer's payment is greater than the market value of the asset that he or she receives; consequently, stabilization network 14 issues him or her compensation in the form of a number N₀ of S-tokens, with a total value equivalent to this excess payment. The number of S-tokens is calculated by dividing the excess payment of the buyer by the price of the S-token:

$${N}_{0} = \frac{\vert V ( l ) - V ( {m}_{0}^{′} ) \vert}{P ( s )}$$

where P(s) is the price of a single S-token. P(s) can be calculated using different methods of valuation, e.g., the book-value, the net-asset-value, the fair-value, or any valid valuation method.

The limit-seller delivers Q(l) of the asset and receives V(m₀′)=P(m₀′)Q(l) in cash plus N₀ S-tokens.

Stabilization network 14 receives V(l)−V(m′) cash, and issues N₀ S-tokens to the seller.

As mentioned above, θ₀ is the stabilization parameter 3a that controls the size of the deduction. It is of a fixed value in this embodiment, but it can be variable (such as a function of the gap between P(l) and P(m) and/or other market conditions).

Exchange platform 12 sets the new market price P(m₀′) as defined above. This is the price at which trade between the sell-limit-order and the buy-market-order is executed. Note that this price will be lower than the limit price P(l), fulfilling an objective of system 10, that is, to reduce the gap between the sell-limit-price and the current market price.

The trade is registered to be executed at P(m₀′), so both parties—the buyer and the seller—get less than they had desired. The buyer pays V(l)=P(l)·Q(l), but gets Q(l) at the price of P(m₀′)<P(l). This means that the buyer pays more than the value of the shares (or other assets) than are received by the buyer. For this reason, the buyer also needs to be compensated: the buyer receives Q(l) shares+N₀ S-tokens (where N₀ is as defined above).

This means that stabilization network 14 issues 2N₀ tokens, i.e., twice the value it receives (discussed further below).

A comparable procedure is followed when it is determined that the gap G is such that G≥α₁, except with stabilization parameter 3b (i.e. θ₁) instead of stabilization parameter 3a (i.e. θ₀), and the number of S-tokens is defined as:

$${N}_{1} = \frac{\vert V ( l ) - V ( {m}_{1}^{′} ) \vert}{P ( s )}$$

The deduction, compensation, and new price calculations are detailed in Table 1.

At this stage, the first row of the table of sell-limit-orders ranked against buy-market-orders has been completed. The above steps are repeated for any remaining rows until all orders are matched.

When the remaining or unmatched market orders are sell orders (excess supply), buy limit orders are ranked against sell market orders, and the above steps are executed with the appropriate change of terms, as shown in the following table—in which P(m)=current market price; P(l)=price limit; Q(l)=quantity limit; V(l)=P(l)·Q(l); Q(m)=quantity market; V(m)=P(m)·Q(m); P(m′)=new market price; P(s)=price of the S-token at time t; 0≤α₀≤1; α₀<α₁<1; 0≤θ₀≤1.

We note that, in case of excess supply, P(m)>P(l), so we have to subtract the net difference (after applying the deduction) from P(m) to obtain the new market price:

P(m₀′)=P(m)−(1−θ₀)(P(m)−P(l))=θ₀P(m)+(1−θ₀)P(l).

This shows that the same weighted average formula is applied in case of both, excess demand and excess supply. Again, this formula ensures that the stabilized price falls within the current market price and the limit price, regardless of the size of the gap between the two.

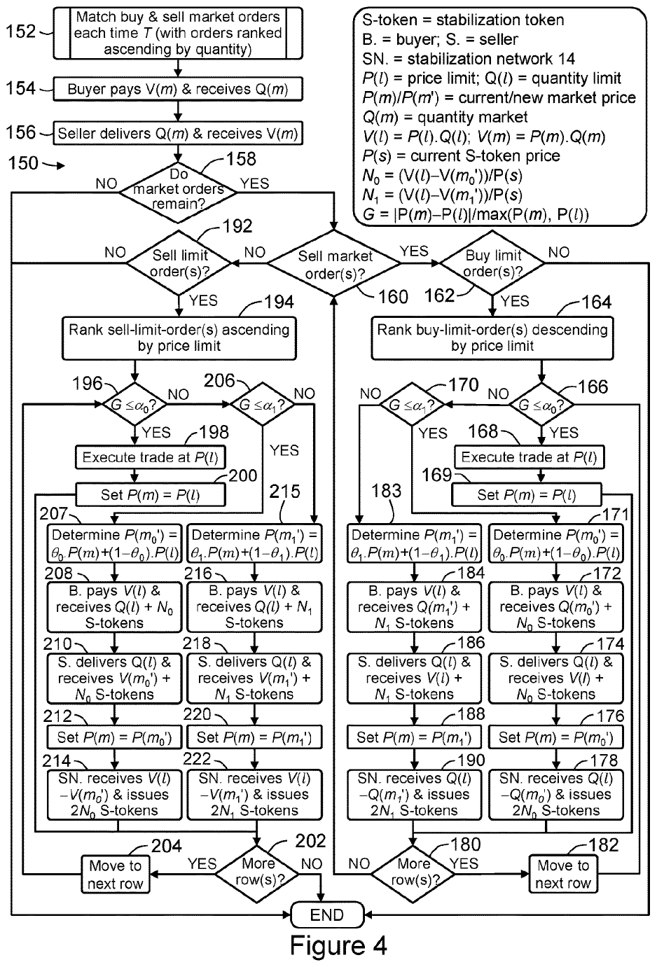

Table 2 summarizes this procedure (which includes a step owing to its use of α₀ and α₁) by reference to flow diagram 150 of FIG. 4.

TABLE 2
Order Processing Procedure

Start
For every period T (e.g., every 30 seconds):
1. Match all buy-market-orders and all sell-market-orders (optionally
after orders have been ranked ascending by quantity) where possible
(step 152)
2. Execute trades between these matched orders such that:
i. Buyers pay V(m) and receive Q(m) (step 154)
ii. Sellers deliver Q(m) and receive V(m) (step 156)
3. Check whether any market orders remain (step 158)
4. If no market-orders remain, End.
5. If market order(s) remain, continue at step 160 and check for any
sell market orders.
6. If remaining market order(s) are sell orders, check whether there
are any buy limit orders (step 162) and, if not, End.
7. If there are buy limit orders, rank buy limit orders descending by
price limit (step 164)
i. For the first remaining row:
a. If G ≤ α₀ (step 166, determined by deduction engine 34),
1) Execute trade at the limit price P(l) (step 168)
2) Price determiner 38 updates market price to be the limit price,
i.e. P(m) = P(l) (step 169)
b. If α₀ < G ≤ α₁ (step 170, determined by deduction engine
34), execute trade as follows:
1) Determine new market price as P(m′₀) = θ₀. P(m) +
(1 − θ₀). P(l) (step 171)
2) Buyer pays V(l) cash and receives Q(m′₀) + N₀ S-tokens
(step 172) (where Q(m′₀) = V(l)/P(m′₀), and the value of
the tokens determined as explained above)
3) Seller delivers Q(l) and receives V(l) = P(l). Q(l) cash + N₀
S-tokens (step 174)
4) Price determiner 38 updates market price P(m) to the new
stabilized price P(m′₀) (step 176)
5) Stabilization network 14 receives Q(l) − Q(m′₀) shares and
issues 2N₀ S-tokens (step 178)
c. If G > α₁ (otherwise), execute trade as follows:
1) Determine P(m′₁) = θ₁ .P(m) + (1 − θ₁). P(l) (step 183)
2) Buyer pays V(l) cash and receives Q(m′₁) + N₁ S-tokens
(step 184) where Q(m′₁) = V(l)/P(m′₁)
3) Seller delivers Q(l) and receives V(l) cash + N₁ S-tokens
(step 186)
4) Price determiner 38 updates market price P(m) to the new
stabilized price P(m′₁) (step 188)
5) Stabilization network 14 receives Q(l) − Q(m′₁) shares and
issues 2N₁ S-tokens (step 190)
8. If there remain one or more rows (step 180), move to the next
remaining row (182) and return to 7.i. (step 166); otherwise continue
to 9 (step 160).
9. If no sell market orders, End.
10. If there remaining buy market orders, check whether there are any
sell limit orders (step 192) and, if not, End.
11. If there are sell limit orders, rank the sell limit orders ascending by
price limit (step 194)
i. For the first remaining row,
a. If G ≤ α₀ (step 196, determined by deduction engine 34),
1) Execute trade at the Limit price P(l) (step 198)
2) Price determiner 38 updates market price to the new market
price, i.e. set P(m) = P(l) (step 200)
b. If α₀ < G ≤ α₁ (step 206, determined by deduction engine 34),
execute trade as follows:
1) Determine P(m′₀) = θ₀. P(m) + (1 − θ₀). P(l) (step 207)
2) Buyer pays V(l) cash and receives Q(l) plus N₀ S-tokens
(step 208)
3) Seller delivers Q(l) cash and receives V (m′₀) cash plus N₀
S-tokens (step 210)
4) Price determiner 38 updates market price P(m) to the new
stabilized price P(m′₀) (step 212)
5) Stabilization network 14 receives V(l) − V(m′₀) cash and
issues 2N₀ S-tokens (step 214)
c. If G > α₁ (otherwise), execute trade as follows:
1) Determine P(m′₁) = θ₁. P(m) + (1 − θ₁). P(l) (step 215)
2) Buyer pays V(l) cash and receives Q(l) plus N₁ S-tokens
(step 216)
3) Seller delivers Q(l) and receives V(m′₁) = P(m′₁). Q(l) cash
plus N₁ S-tokens (step 218)
4) Price determiner 38 updates market price P(m) to new
stabilized price P(m′₁) (step 220)
5) Stabilization network 14 receives V(l) − V(m′) cash and
issues 2N₁ S-tokens (step 222)
12. If there remain one or more rows (step 202), move to the next
remaining row (step 2004) and return to 11.1. (step 196); otherwise
End.
End

Note that, after steps 164 and 194, market orders (respectively sell-market-orders and buy-market-orders) should be ranked ascending by quantity, owing to the optional ranking of orders ascending by quantity of earlier step 152. However, should there be any doubt in that regard (e.g. the optional ranking of step 152 was omitted), steps 164 and 194 should additionally include, respectively, “rank sell-market-order(s) ascending by quantity” and “rank buy-market-order(s) ascending by quantity”.

An alternative procedure is followed if the throttling parameter is defined as a smooth function for all values of G above α₀. For example, the throttling parameter θ* may be defined (as discussed above) by:

$${θ}^{*} = \{ \begin{matrix}0 , if G \leq {α}_{0} \\ {G}^{{θ}_{0}} , if G > {α}_{0}\end{matrix}$$

where 0<θ₀<1. There will be an excess supply of the asset when there are net sell-market-orders. In this case, the buy-limit-price will be lower than the current market price, P(l)<P(m). Hence, in this example, the deduction procedure is as follows:
1. If G≤α₀, then no deduction applies, and the stabilized price will simply be the limit-buy price, i.e., P(m′)=P(l).
2. If G>α₀, then the adjusted or new market price will be:

P(m′*)=θ*·P(m)+(1−θ*)P(l).

The same formula is applied for both excess demand and excess supply, as explained above.

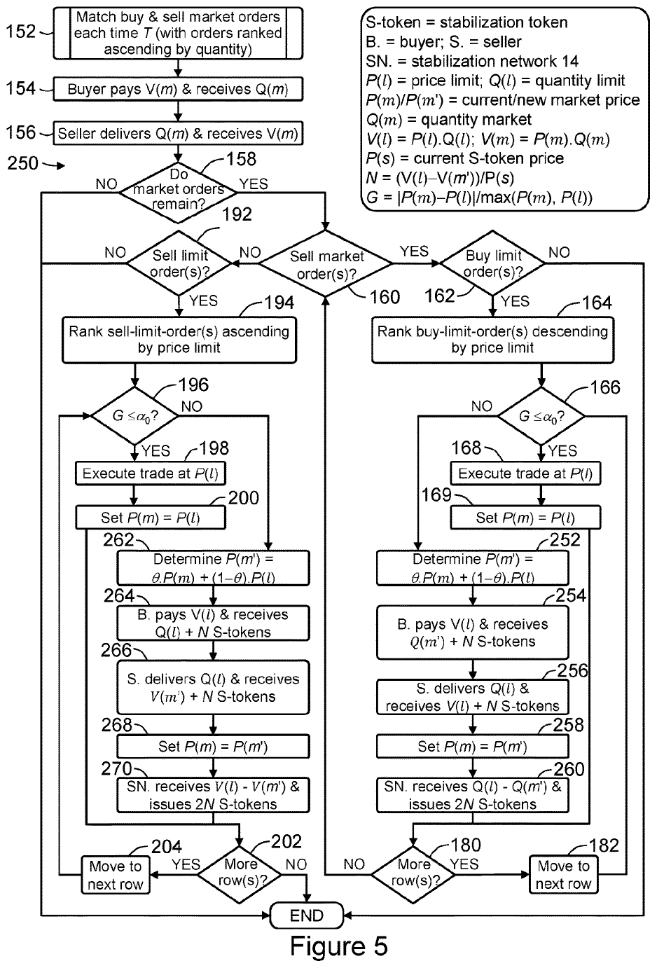

The approach of this alternative embodiment is shown schematically in flow diagram 250 of FIG. 5. The process is essentially the same as in Table 2 except using a single or unified throttling parameter, θ*, instead of two (viz. θ₀ and θ₁), and like reference numerals have been used to identify like steps. (For simplicity, the star superscript is omitted from θ* in FIG. 5.)

However, in flow diagram 250, if at step 166 deduction engine 34 determines that G>α₀, processing continues at step 252 in all cases in this example, as a second stabilization parameter (α₁) is not employed. At step 252, price determiner 38 determines the adjusted price P(m′*)=θ*·P(m)+(1−θ*)P(l). At step 254, in case of excess supply, the buyer pays V(l) and receives Q(m)=V(l)/P(m′*) and N S-tokens, where

$$N = \frac{\vert V ( l ) - V ( {m}^{′ *} ) \vert}{P ( s )} .$$

At step 256, the seller delivers Q(l) receives V(l)+N S-tokens, and at step 258, price determiner 38 updates the price P(m) to the new or adjusted price P(m′*). At step 260, stabilization network 14 receives Q(l)−Q(m′*) and issues 2N S-tokens. Processing then continues at step 180.

If, at step 196, deduction engine 34 determines that G>α₀, processing continues at step 262 where price determiner 38 determines the adjusted price P(m′*)=θ*·P(m)+(1−θ*) P(l). At step 264, in case of excess demand, the buyer pays V(l) and receives Q(l) and N S-tokens. At step 266, the seller delivers Q(l) and receives V(m′x)=P(m′*)·Q(l) and N S-tokens. At step 268, price determiner 38 updates the price P(m) to the new or adjusted price P(m′*). At step 270, stabilization network 14 receives V(l)−V(m′*) and issues 2N S-tokens. Processing then continues at step 202.

### Funding the Stabilization Tokens

The deduction (when applied) means that the buyer and seller are surrendering some of their value owing, so each should be compensated. However, exchange platform 12 is configured to collect from only one of them, so stabilization network 14 issues tokens equivalent to twice the collected resources of the stabilization fund. In other words, the S-tokens are 50% covered, not 100%; this arises from the fact that the trade is executed between the buyer and the seller at the adjusted price, which affects both parties at once, while the deduction is applied to only one of them. Hence, if the fund were liquidated completely, only 50% of the tokens would be reimbursed.

If system 10 is viewed as a cooperative insurance system, then a 50% funding or reserve ratio is much better than the standard ratio in the insurance industry. Nonetheless, we aim for the better, and so we propose a set of parameters to ensure the viability and stability of exchange platform 12.

As already discussed, the S-tokens will be subject to restrictions on trading or redemption to give the Network enough time to grow and accumulate funds (cash and assets). These restrictions can be designed to avoid “runs” on the Network and ensure the ability to redeem each token from the available reserves. For example, the tokens cannot be redeemed before 18 months from the date of issuance.

To avoid redemption problems (or ‘runs’), blockchain consensus engine 46 can enforce different dates for different traders. The owner of the limit-order tends in general to be more patient that the owner of the market order, so the redemption date for the market-order tokens can be set earlier by blockchain consensus engine 46 than that of the limit-order (e.g., earlier by one month). To compensate the limit-order owner, the date of trade of the S-tokens can be ahead of the market order. For example, the redemption period for the market order could be 18 months, and the trading period also 18 months, from issuance. For the limit-order, the redemption period would then be, in this example, 19 months, and the trading period 17 months. The exact values of these dates or periods can be adjusted as suitable for users of exchange platform 12 via administrator interface 18 and/or blockchain consensus engine 46.

Stabilization network 14 may optionally include a dedicated A.I. engine, trained to guide the consensus regarding the periods of redemption and trade, such as to increase the periods in response to a greater risk of run.

In this manner, no more than 50% of tokens can be redeemed within any given month (or any suitable unit period). Owing to the flow of the deductions to the Network, the Network can accumulate funds (cash and assets) to meet the requests for redemption for the next month, and so on. The Network is therefore able to support the S-tokens while facing little risk of a run. In case of exceptional circumstances, trading and redemption can be suspended until the market stabilizes.

It will be noted that investors or traders have the incentive to keep the value of the S-tokens stable (e.g., $1 per S-token), because these tokens compensate them for the deductions. The redemption system thus provides harmony between the mechanics of the system and the incentives of traders.

### Example

This example elaborates on the procedure described above, and supposes that the current market price (i.e. the price at which the last transaction trading the asset in exchange platform 12 was executed) of shares in company XYZ is $100. A list of notional market and limit orders is presented in Table 3.

TABLE 3
Market Orders and Limit orders

| Buy Orders | | | Sell Orders | | |
|---|---|---|---|---|---|
| Limit Orders | | | Limit Orders | | |
| (sorted by | | | (sorted by | | |
| price ↓) | | Market | price ↑) | | Market |
| Limit | Limit | Orders (↑) | Limit | Limit | Orders (↑) |
| Price | Quantity | Quantity | Price | Quantity | Quantity |
| 62 | 2,918 | 1,385 | 112 | 1,658 | 1,895 |
| 56 | 1,915 | 2,857 | 116 | 3,665 | 1,329 |
| 51 | 1,703 | 3,028 | 132 | 3,376 | 2,755 |
| 50 | 3,207 | 2,775 | 139 | 2,658 | 2,753 |

The market orders are initially matched (as they do not affect the current market price), as shown in Table 4.

TABLE 4
Total Market Orders

| Buy | Sell | Net |
|---|---|---|
| 10,045 | 8,732 | Buy 1,303 |

There are, in this example, net buy-market-orders, so they are matched with sell-limit-orders. From Table 3, the first sell-limit-order is at price 112 for a quantity 1,658. The minimum of the two quantities therefore is 1,313. Hence, in the absence of stabilization, the trade transaction will be executed at price $112 for a quantity 1,313 share. The new market price becomes $112. With this transaction, there is no more market orders, and therefore no trade will take place until the next trading session.

TABLE 5
Orders

| | |
|---|---|
| Buy Market | Sell Limit |
| Orders | Orders |

| Quantity | Quantity | Price |
|---|---|---|
| 1,313 | 1,658 | 112 |

This example employs a continuous stabilization function, as discussed above, whereby

θ₁=G^{θ}^{₀},0<θ₀<1,

G=|P(m)−P(l)|/(max(P(m),P(l))),

and:

$${θ}^{*} = \{ \begin{matrix}0 , if G \leq {α}_{0} \\ {θ}_{1} , if G > {α}_{0}\end{matrix}$$

It will be noted that the gap between supply and demand (based on price) is G=|100−112|/112=10.71%. If, for example, α₀=5% (and hence G>α₀) and θ₀=0.75, then θ*=θ₁=(10.71%)^{0.75}=18.72% and the stabilized or adjusted price will be:

P(m′)=(18.72%*100)+(1−18.72%)*112=109.75

The trade transaction therefore takes place at price $109.75, which is lower than the limit-price of $112. The seller is surrendering in total V(l)−V(m′)=(112−109.75)*1,313=$2,950.65. The seller and the buyer, therefore, need to be compensated, each, by S-tokens of an equivalent value.

With stabilization, the new market price is $109.75. Again, with this transaction, there are no more market orders, so no trade will take place until the next trading session.

### Simulations

Monte Carlo simulations of the operation of system 10 were conducted, at two levels: static and dynamic.

In a static simulation, price volatility was determined by simulating both system 10 and system without stabilization. In a dynamic simulation, price volatility moving from one session to another was examined, again with both system 10 and system without stabilization.

### Static Simulation

The following parameters and variables were employed:

TABLE 6
Simulation Parameters Used in Static Monte Carlo Simulation

| Parameter | Value |
|---|---|
| α₀ | 5% |
| θ₀ | 0.75 |
| Initial price t = 0 | $100 |
| Price distribution-limit-buy | Pₜ = 1~uni(40:99) |
| Price distribution-limit-sell | Pₜ = 1~uni(101:160) |
| Quantity distribution | Qₜ =1~uni(2,500 ± 60%) |
| No. of iterations | 50,000 |

It will be noted that price distribution for buy limit-orders is different from that of sell limit-orders. For limit-buy, the price is uniformly distributed between 40 and 99. The current (initial) market price of $100 is not included in the distribution as this will make the order a market order. Similarly, for sell limit-orders, the price is uniformly distributed between 101 and 160.

The simulation was conducted using @Risk 8.2. The results are summarized in Table 7.

TABLE 7
Static Simulation Results

| | Without stabilization | | | With Stabilization | | |
|---|---|---|---|---|---|---|
| | P | Q | V | P | Q | V |
| Mean | 99.95 | 1,970 | 196,947 | 100.6 | 1,905 | 192,545 |
| Median | 101.0 | 1,673 | 162,713 | 101.0 | 1,631 | 160,902 |
| Std | 21.8 | 1,465 | 155,117 | 13.6 | 1,405 | 148,292 |
| 10%- | 71- | 318- | 30,993- | 82-119 | 311- | 30,658- |
| 90% | 128 | 4,052 | 405,993 | | 3,895 | 396,253 |
| interval | | | | | | |

Overall, the stabilization algorithm reduces the standard deviation of price by about 37%, from 21.8 to 13.6. Although the two scenarios have essentially the same mean and median, the 10%-90% interval (10% percentile and 90% percentile) is shorter for the stabilized system: 71-128 vs. 82-119. The reduction is about 35%.

Q represents the limit-quantity of the asset at which transactions took place. There is a slight reduction in the average as well as the standard deviation of the quantity with stabilization. A similar pattern appears also in V, price times quantity for each limit-transaction. This is natural given the deduction in quantity in case of excess supply, as explained above.

The average of total assets of the stabilization network is $9,809 (see Table 8). This represents about 4.8% of the limit volume of trade. Since the number of S-tokens issued is twice this amount, on average $19,618 worth of S-tokens were issued for Round 1.

TABLE 8
Stabilization Network (Fund), Round 10 Only

| | | Asset | Total | Total |
|---|---|---|---|---|
| | Cash | (quantity) | assets ($) | assets/V |
| Mean | 4,402 | 64.98 | 9,809.39 | 4.75% |
| Median | 0 | 0 | 87,231 | 47.38% |
| Std | 11,056 | 173.25 | 16,508 | 6.65% |
| 10%-90% | 0-13,822 | 0-198.73 | 0-27,792 | 0-11.69% |
| interval | | | | |

### Dynamic Simulation

In the dynamic simulation, the same assumptions about the parameters and variables as in the static simulation were employed for the initial round. However, for the subsequent rounds, the initial price will be the market price resulting from the last transaction of the previous round. This creates a dynamic dependence of each round on the previous one, which is closer to the real world than assuming a single round.

To control the analysis, it was assumed that this dependence is related to the price only. Quantity is assumed to have the same distribution for each round independent of the previous one. This helps to narrow down the source of volatility and simplify the analysis.

Preliminarily, the simulation was run for 10 rounds, for ease of analysis, but entailed the 10-round sequence run 50,000 times. Table 9 summarizes the assumptions for the dynamic simulation. The results are summarized in tables 10 and 11.

TABLE 9
Simulation Parameters Used in Dynamic Monte Carlo Simulation

| Parameter | Value |
|---|---|
| α₀ | 5% |
| θ₀ | 0.75 |
| Initial price t = 0 | $100 |
| Price distribution-limit-buy | Pₜ~uni(0.4 Pₜ₋₁:Pₜ₋₁ − 1) |
| Price distribution-limit-sell | Pₜ~uni(Pₜ₋₁ + 1:1.6 Pₜ₋₁) |
| Quantity distribution | Qₜ~uni(2,500 ± 60%) |

TABLE 10
Dynamic Simulation Results, Round 10 only

| | Without stabilization | | | With Stabilization | | |
|---|---|---|---|---|---|---|
| | P | Q | V | P | Q | V |
| Mean | 99.95 | 1,970 | 196,981 | 105.5 | 1,907 | 200,580 |
| Median | 79.2 | 1,683 | 121,543 | 97.04 | 1,638 | 156,378 |
| Std | 77.03 | 1,448 | 239,680 | 41.10 | 1,187 | 175,455 |
| 10%- | 30-194 | 318- | 18,799- | 62-159 | 310- | 29,117- |
| 90% | | 4,022 | 457,992 | | 3,882 | 424,723 |
| interval | | | | | | |

TABLE 11
Dynamic Simulation Results, 10 Rounds

| | Without stabilization | | | With Stabilization | | |
|---|---|---|---|---|---|---|
| | P | Q | V | P | Q | V |
| Mean | 100.07 | 1,946 | 196,781 | 102.24 | 1,882 | 192,984 |
| Median | 91.40 | 1,926 | 173,521 | 98.59 | 1,862 | 181,732 |
| Std | 45.33 | 456 | 102,684 | 25.48 | 436 | 68,349 |
| 10%- | 52-159 | 1,373- | 95,118- | 73-136 | 1,334- | 117,311- |
| 90% | | 2,549 | 325,761 | | 2,456 | 283,038 |
| interval | | | | | | |

Table 10 reports the results for the last round of trading, round 10 only. The standard deviation of the price dropped from 77 without stabilization to 41 with stabilization, a 46% reduction. Also, the 10%-90% interval (the range between the 10% and 90% percentiles) shrinks from 52-159 to 73-136, a 41% reduction. The average price is little higher in case of stabilization, while the median is notably higher. This reflects the dispersion of the price distribution without stabilization.

V is the volume of limit-order trades, price times quantity for transactions affecting the price and therefore subject to stabilization. Market-orders trades are not reported here as they have no impact on price. Average limit-volume is slightly higher in case of stabilization, while the median is notably higher. The standard deviation is substantially lower in case of stabilization. This is remarkable as it indicates the improvement in stability of not only price but volume as well.

Table 11 shows the results for the 10-rounds sequence. These results show the average of the price for all 10 rounds, after repeating the sequence for 50,000 times. The same pattern is observed as in round 10. Standard deviation is reduced from 45.3 to 25.5, a 43% drop. The 10%-90% interval shrinks from 52-159 to 73-136, about a 40% reduction.

For volume, a lower average will be noted, but a higher median in the case with stabilization. It also exhibits a lower standard deviation, and the 10%-90% interval also drops by about 30%, indicating the increased stability of volume.

For stabilized system 10, the cumulative deductions were measured for each 10-rounds sequence. The results are presented in Table 12. Notably, the stabilization fund of stabilization network 14 accumulated about 52% of the volume of limit-transactions. This indicates that, over longer periods, stabilization network 14 should be able to accumulate substantial assets without affecting the actual trade volume in the exchange. Stabilization network 14, therefore, has the potential to provide a solid line of defence for the stability of the market.

TABLE 12
Stabilization Network (Fund), 10 Rounds, Cumulative

| | | Asset | Total | Total |
|---|---|---|---|---|
| | Cash | (quantity) | assets ($) | assets/V |
| Mean | 43,605 | 643.56 | 100,476 | 52.41% |
| Median | 30,765 | 493.54 | 87,231 | 47.38% |
| Std | 42,983 | 561.82 | 61,858 | 26.51% |
| 10%-90% | 6,337- | 99.68- | 38,049- | 24%-87% |
| interval | 96,861 | 1,395.64 | 178,186 | |

Thus, the reserves of stablecoin or ‘S-tokens’ are built internally (i.e. within stabilization network 14) through the management of excess supply and demand, without relying on bond tokens or share tokens. Moreover, the parameters of the liquidation of the stabilization fund units play the role of managing the supply of the stablecoin. System 10 preemptively intervenes to stabilize the price ahead of changes in the balance of supply and demand.

System 10 thus employs a stablecoin adapted so that system 10 can preemptively intervene to stabilize price ahead of changes in the balance of supply and demand (in essence, ahead of price changes) to stabilize the stablecoin, and accumulate reserves in a fund to provide another source of stablecoin stabilization. Thus, the stablecoin of this embodiment: does not require upfront capital—it is self-financed; manages excess supply or demand of the stablecoin; proactively works to reduce price changes; and scales in proportion to the use of the stablecoin.

### DISCUSSION

System 10, by integrating a layer with a centralized network architecture and a layer with a decentralized network architecture, increases stability without overly compromising efficiency. As applied to a capital market, system 10 also differs from existing approaches in three major respects:
1) System 10 manages the pressure on price before the price changes, so is forward-looking. Conventional strategies aim to contain price volatility after the price changes so are backward-looking.
2) System 10 is self-financed, and investors' rights are protected.
3) The Stabilization Fund, while self-financed, offer an additional layer of stabilization in major crises or market meltdown.

It might be suggested that system 10 does not satisfy the requirements of the traders: the seller who puts a limit on the price receives shares less in value than requested, and similarly for buyers; traders do not know exactly how much they will receive in asset or how much the value of the asset they will receive.

Such concerns, however, are common in modern financial markets. For example, circuit breakers may cause suspension of trade and cancelation of orders without prior notice. Under the Third Basel Accord (the regulatory framework on bank capital adequacy, stress testing, etc, also known as known as ‘Basel III’), holders of Tier 1 additional capital instruments do not know exactly when regulators will decide to write off their papers.

However, the uncertainties in system 10 are contained: all traders receive the majority of requested trade (cash or asset), while the remaining part in S-tokens. Traders have the ability, given the restrictions on the S-tokens, to preserve the value of the S-tokens and thus be highly confident of the overall value of their trades.

Compared to taxes, the deductions of system 10 offer a better compensation scheme. Traders pay taxes and this causes a divergence in their request from the actual result they get. However, system 10 offers traders the S-tokens in compensation for the deductions, unlike taxes which are not compensated for in any direct manner.

System 10 may thus be viewed as an insurance system, in which the deductions may be compared to insurance premiums with traders paying the premiums to stabilize their investments. The insurance premiums are variable, but the compensation to these premiums is stable as well. As noted above, it is in the interest of traders to keep the value of the S-tokens stable (such as at $1 per token), which maximizes the extent to which the S-tokens—under the ordered redemption mechanism—are covered.

Overall, system 10 aims to stabilize the value of the asset. Stabilization, like insurance, has a cost, and the users of system 10 (viz, the traders) bear this cost so that system 10 is stable.

### DISCUSSION

Analogy with Physical Systems

It may be useful, in ascertaining the invention, to consider system 10 by analogy with the physical system of a sink or basin with a drain and an overflow outlet. Should water flow into the sink faster than the drain can remove water, the water level will rise to the level of the overflow outlet-which provides additional draining. This is not yet a stabilization system. To create a stabilization system, the water drained from the overflow outlet is deposited into a reservoir that can be used in case of low inflow of water (using a pump, for example). This is a static stabilization system.

To transform this stabilization system into a ‘smart’ or dynamic stabilization system, the gap function between the inflow and outflow rates is determined. (The gap is a function because these rates will vary with water depth.) The size of the overflow outlet is adjusted dynamically (i.e. opened or throttled) based on this gap function: the larger the gap, the larger the overflow outlet. Alternatively, a pump in or attached to the overflow outlet can be used to speed or retard the removal of water via the overflow outlet, draining water at a higher speed when the water level is higher. (The same pump can be used to bring water from the reservoir in case of low inflow of water.)

This a dynamic stabilization system, but it is not sustainable. To be sustainable, the system needs to obtain the energy for the dynamic adjustment of the overflow outlet's capacity from the inflow itself. For example, the higher the water level in the sink, the larger its weight, and this additional weight (due to gravity) can be used as a source of energy.

Moreover, the higher the water level, the faster the rate of draining (and therefore the greater the force of the draining water), which may also be used as a source of energy. The gap between the inflow and outflow of water can be classified based on a parameter α, with multiple values, e.g., α₀ and α₁. When the gap exceeds do the overflow pump will work to drain the water. The speed of the overflow pump is then the analogue of θ of system 10, and so on.

### CONCLUSION

System 10 is thus a general-purpose system to contain and mitigate price volatility in organized exchanges. It is a forward-looking system that seeks to manage the gap between supply and demand in an orderly fashion. The same system can be applied to digital or cryptocurrencies to create stablecoins. The self-financed Stabilization Fund adds another line of defense against price volatility.

### REFERENCES

Bloomberg, https://www.bloomberg.com/news/articles/2022-05-03/citi-s-painful-flash-crash-highlights-market-risks-from-algos (2022).
The Balance, https://www.thebalance.com/what-is-a-flash-crash-3306184 (2022).
Ian Stewart, In Pursuit of the Unknown: 17 Equations That Changed the World, Basic Books (2013) p. 314.
Vinu V. Das, Janahanlal Stephen, and Yogesh Chaba, Computer Networks and Information Technologies, Springer (2011), p. 224.
James A. Momoh and Mohamed E. El-Hawary, Electric Systems, Dynamics, and Stability with Artificial Intelligence Applications, CRC Press (2018), p. 23.
Nikos Hatziargyriou and lony Patriota de Siqueira, Electricity Supply Systems of the Future, Springer Nature (2020), p. 468.
Mitchell, C. and Boyle, M., Market Price, Investopedia, www.investopedia.com (15 Nov. 2020)
Al-Naji, N., et al., Basis: A Price-Stable Cryptocurrency with an Algorithmic Central Bank, (2018) www.basis.io

It will be understood to persons skilled in the art of the invention that many modifications may be made without departing from the scope of the invention. In particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A computer-implemented network stabilization method, the method comprising:
receiving a plurality of commands at a controller;
converting the commands with the controller into a set of computer-executable actions;
generating from the computer-executable actions with the controller a first command signal and a second command signal, according to one or more control parameters that are generated by or accessible by the controller;
sending the first command signal from the controller to a first computing system having a centralized network architecture; and
sending the second command signal from the controller to a second computing system having a decentralized network architecture;
wherein the first command signal is configured to control the first computing system to execute a first subset of the set of computer-executable actions; and
the second command signal is configured to control the second computing system to execute a second subset of the set of computer-executable actions.

2. A method as claimed in claim 1, wherein the second computing system comprises a peer-to-peer network configured for hosting a publicly distributed ledger.

3. A method as claimed in claim 1, wherein the commands are indicative of purchases, sales or other financial transactions.

4. A method as claimed in claim 1, wherein the set of computer-executable actions constitute a trade comprising a purchase and a sale.

5. A method as claimed in claim 1, wherein:
a first at least one of the commands is a purchase command indicative of a purchase of a product or asset, and a second at least one of the commands is a sale command indicative of a sale of the product or asset;
converting the commands into the set of computer-executable actions comprises pairing or matching the purchase command and the sale command and generating a matched purchase and sale command; and
generating the first command signal and the second command signal comprises forming a comparison between at least one parameter pertaining to the purchase command and at least one parameter pertaining to the sale command.

6. A method as claimed in claim 5, wherein:
forming the comparison comprises comparing a sell limit order and a buy market order and/or comparing a buy-limit-order and a sell market order.

7. A method as claimed in claim 5, wherein
the at least one parameter pertaining to the purchase command and to the sale command is price of the product or other asset; and
generating the first command signal and the second command signal comprises generating a deduction applicable to the price, such that first command signal and the second command signal are both functions of the deduction.

8. A method as claimed in claim 5, comprising:
generating the first command signal to comprise either the sale command adjusted according to the deduction and the purchase command, or the purchase command adjusted according to the deduction and the sale command; and
generating the second command signal to comprise the deduction.

9. A method as claimed in claim 1, wherein the first computing system comprises the controller.

10. A network stabilization system, comprising:
a controller;
a first computing system having a centralized network architecture; and
a second computing system having a decentralized network architecture;
wherein the controller is configured to receive a plurality of commands, to convert the commands into a set of computer-executable actions, to generate from the computer-executable actions a first command signal and a second command signal according to one or more control parameters that are generated by or accessible by the controller, and to send the first command signal to the first computing system and the second command signal to the second computing system;
the first command signal is configured to control the first computing system to execute a first subset of the set of computer-executable actions; and
the second command signal is configured to control the second computing system to execute a second subset of the set of computer-executable actions.

11. A system as claimed in claim 10, wherein the second computing system comprises a peer-to-peer network configured for hosting a publicly distributed ledger.

12. A system as claimed in claim 10, wherein the commands are indicative of purchases, sales or other financial transactions.

13. A system as claimed in claim 10, wherein the set of computer-executable actions constitute a trade comprising a purchase and a sale.

14. A system as claimed in claim 10, wherein:
a first at least one of the commands is a purchase command indicative of a purchase of a product or asset, and a second at least one of the commands is a sale command indicative of a sale of the product or asset;
converting the commands by the controller into the set of computer-executable actions comprises pairing or matching the purchase command and the sale command and generating a matched purchase and sale command; and
generating the first command signal and the second command signal by the controller comprises forming a comparison between at least one parameter pertaining to the purchase command and at least one parameter pertaining to the sale command.

15. A system as claimed in claim 14, wherein:
forming the comparison comprises comparing a sell limit order and a buy market order and/or comparing a buy-limit-order and a sell market order.

16. A system as claimed in claim 14, wherein
the at least one parameter pertaining to the purchase command and to the sale command is price of the product or other asset; and
generating the first command signal and the second command signal by the controller comprises generating a deduction applicable to the price, such that first command signal and the second command signal are both functions of the deduction.

17. A system as claimed in claim 14, wherein:
the first command signal comprises either the sale command adjusted according to the deduction and the purchase command, or the purchase command adjusted according to the deduction and the sale command; and
the second command signal comprises the deduction.

18. A system as claimed in claim 10, wherein the first computing system comprises the controller.

19. A computer program comprising program code configured, when executed by one or more computing devices, to implement the method of claim 1.

20. A computer-readable medium, comprising a computer program as claimed in claim 19.
